(19) United States
(12) Patent Application Publication
(10) Pub. No.: US 2011/0203185 A1
(43) Pub. Date: Aug. 25, 2011

(54) PAINTED SURFACE TREATING COMPOSITION, A PAINTED SURFACE TREATING METHOD AND A PAINTED SURFACE PATCHING METHOD

(76) Inventors: Zhongmin Wang, Shanghai (CN); Yungang Zhu, Shanghai (CN)

(21) Appl. No.: 12/937,281

(22) PCT Filed: Apr. 27, 2009
(86) PCT No.: PCT/US09/41787

§ 371 Date: Oct. 11, 2010

(30) Foreign Application Priority Data
May 26, 2008 (CN) 200810098978.0

(51) Int. Cl. C09K 3/14

(52) U.S. Cl. 51/298; 51/307; 51/304

(57) ABSTRACT

This invention provides a painted surface treating composition which includes a dispersion medium and an abrasive dispersing in the dispersion medium, and said abrasive has an average particle diameter of 12-55 μm and a Mohs' hardness of 5.5-6. A painted surface treating method and a painted surface patching method using this painted surface treating composition are also provided.

### FIELD OF THE INVENTION

The present invention relates to a painted surface treating composition, a painted surface treating method and a painted surface patching method, and particularly, to a composition for treating a painted surface with low glossiness, especially a grinding paste for painted surface with low glossiness, to as well as a painted surface treating method and a painted surface patching method utilizing this painted surface treating composition.

### BACKGROUND

Matte surfaces are an important application representation in the coating and paint industry. In daily life, the articles with matte effect can be seen everywhere: they can be encountered in home, on the road to work, or in restaurants under curtain of night. Indoor furniture mostly utilizes a matte surface and the wooden boards coating the exterior of eateries also basically have matte appearances. When being confronted with the choice for a glossy effect or a matte effect, we are not only limited to a demand of style and appearance. The practice has proved that the demands in the aspects of cleaning ability, glossy effect and touch or feeling or the like also affect our choice. When we go to offices, whether by driving, by bus, or by train, we will find that the inner decorative surfaces of various vehicles are basically matte surfaces. In view of the aspects of actual use and safety, the blackboards in schools all utilize matte surfaces to avoid glare. The interior of automobiles also utilize that kind of design, and in view of safety, some economical and practical devices and inner decorations all utilize the dull flat paints.

Anti-light reflection is a subject with significant meaning. The surfaces of skyscrapers are generally not coated with the gloss coatings, instead, pre-painted boards are coated on the substrates of steel or aluminum, and additionally, matte coatings are used without exception so as to avoid producing dangerous light reflection to stimulate the eyes of passengers or drivers.

Additionally, economic utility is another important factor for selecting to the surface state of the coatings. For example, when some substrates are scuffed, have minute pits or are contaminated, these defects can be covered by utilizing the matte coatings, however, this kind of flaws is hard to be covered up by coating with gloss paints.

Matte finish is a method for obtaining a painted surface with low glossiness. However, the storage life and condition of the paint are all more rigorous than those of the ordinary paints.

U.S. Patent Application Publication No. 2001/0056146 discloses a mixed preparation agent which can obtain a matte effect on the surfaces of floor and culinary surfaces. However, the duration of the matte effect produced by the preparation agent is limited.

EP Patent No. 1013731 discloses a mixed solvent containing a polymeric film-forming agent which can also obtain a matte effect. The usage of solvent limits the application range thereof.

U.S. Patent Application Publication No. 2005/0166464 is also a grinding paste containing an abrasive, however, it can only obtain a painted surface effect with high glossiness.

If the grinding products of sand paper and the like are used, though the matte effect can be obtained, sand marks will be left on the painted surface.

In summary, the technologies disclosed by the above references can not obtain a long matte effect on the painted surface simply and conveniently. Additionally, the flat paints also have the limitation of storage time and storage condition.

Therefore, it is demanded for a painted surface treating composition which can obtain a matte effect on painted surface without obvious sand marks.

### DISCLOSURE OF THE INVENTION

The invention obtains a new grinding paste with low glossiness by selecting an abrasive with appropriate particle size and hardness.

Specifically, the invention provides a painted surface treating composition which includes a dispersed medium and an abrasive dispersing in the dispersed medium, wherein said abrasive has an average particle diameter of 12-55 μm and a Mohs' hardness of 5.5-6.

According to certain embodiments, the painted surface treating composition of the invention further comprises a rheological agent of anionic hydrophobic-modified acrylic alkali-swelling thickening agent or the like.

According to certain embodiments, in the painted surface treating composition of the invention, said dispersed medium is an environmentally friendly water-oil dispersion emulsion.

According to certain embodiments, in the painted surface treating composition of the invention, said abrasive comprises 35-50% of the total weight of the system.

According to certain embodiments, in the painted surface treating composition of the invention, said abrasive is pyrolutite.

According to certain embodiments, in the painted surface treating composition of the invention, the particle diameter distribution D₉₀ of said abrasive is between 30-110 μm.

The invention further provides a painted surface treating method including applying the painted surface treating composition of the invention on a substrate.

Still another aspect of the invention provides a painted surface defect patching method including applying the painted surface treating composition of the invention on a painted surface to be patched.

For the traditional painted surface treating compositions, if there are flaws on the matte painted surface, it can only firstly remove the flaws and then perform an overall re-coating on the surface to obtain a uniform painted surface. If the painted surface grinding paste with low glossiness of the invention is used, it is only demanded to perform a treatment in a small range to obtain a uniform surface effect.

### DESCRIPTION OF THE DRAWING

FIG. 1a is a schematic view of light reflection routes on a surface with high glossiness, FIG. 1b is a schematic view of light reflection routes on a matte surface, and FIG. 1c is a schematic view of light reflection routes on a matte surface with sand marks.

FIG. 2 is a particle diameter distribution diagram of HP 4O/N abrasives; the particle size distribution thereof is relatively narrow and concentrated, and the average particle size thereof is 54 μm.

FIG. 3 is a particle diameter distribution diagram of Dymco-325 abrasives; the particle size distribution thereof is relatively narrow and concentrated, and the average particle size thereof is 38 μm.

FIG. 4 is a particle diameter distribution diagram of LHM-325 abrasives; the particle size distribution thereof is relatively narrow and concentrated, and the average particle size thereof is 15 μm.

FIG. 5 is a particle diameter distribution diagram of Double Cream Tripoli diatomite abrasives; the particle size distribution thereof is relatively wide, and the average particle size thereof is 25 μm.

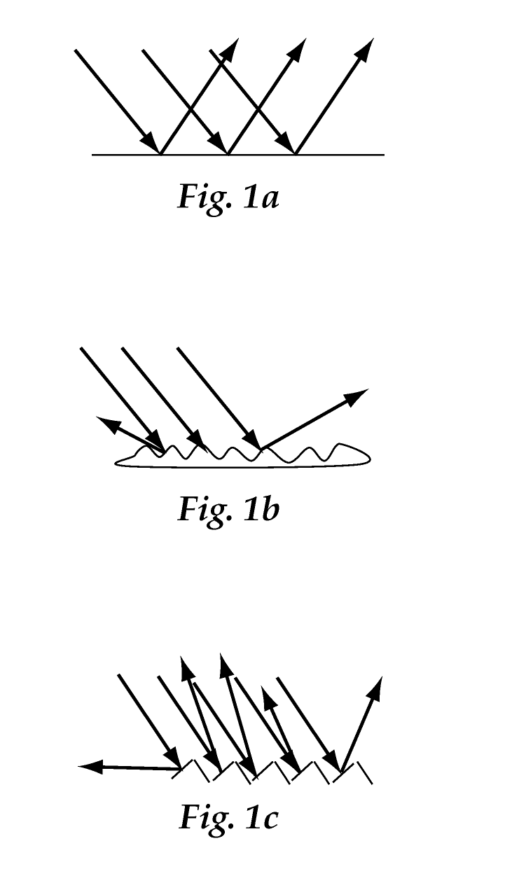

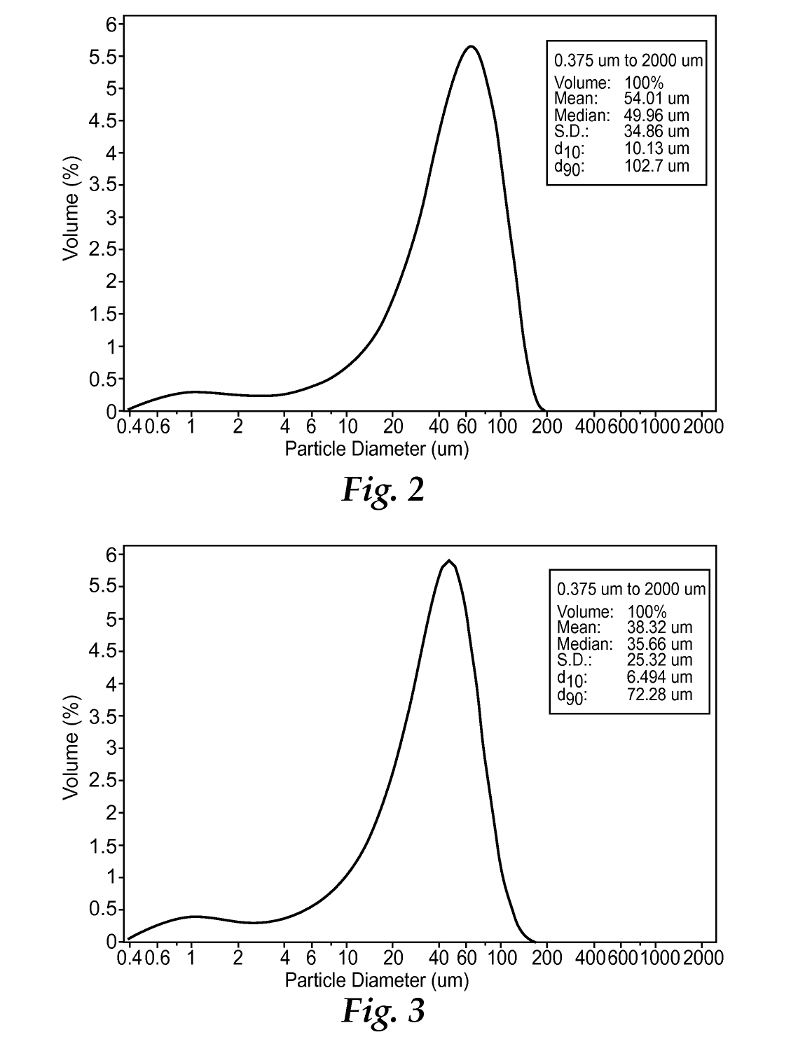

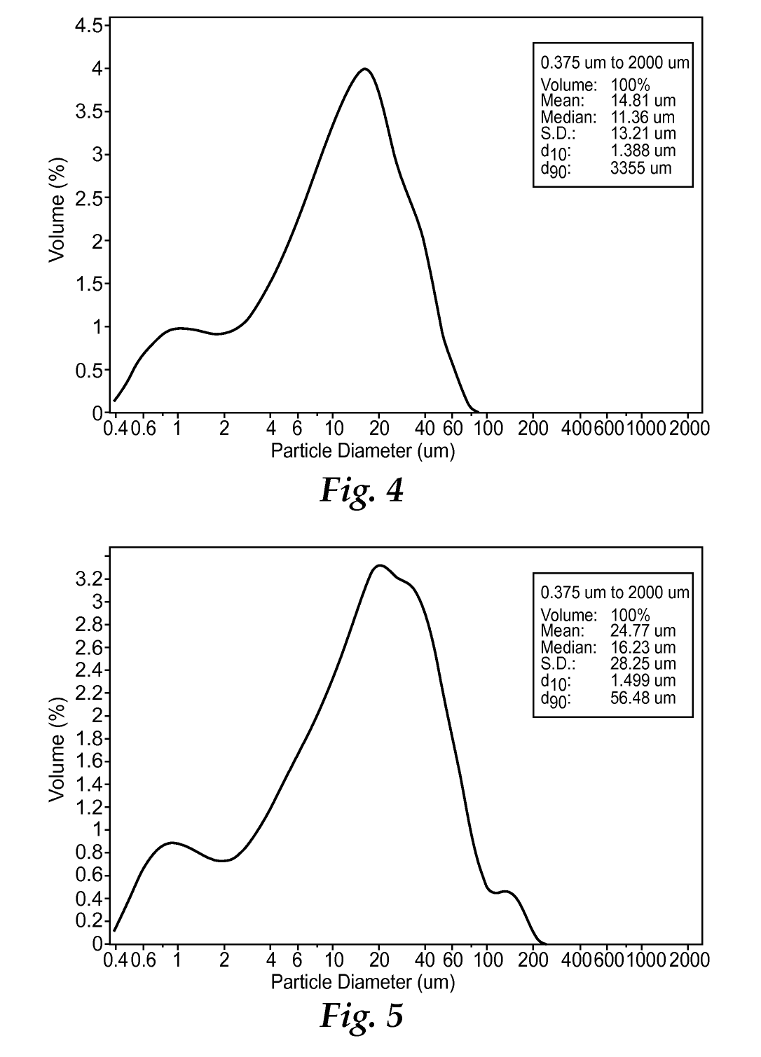

### SPECIFIC MODE OF CARRYING OUT THIS INVENTION

The invention provides a painted surface treating composition (that is, a painted surface treating composition) which includes a dispersed medium and an abrasive dispersing in the dispersed medium, wherein said abrasive has an average particle diameter of 12-55 μm and a Mohs' hardness of 5.5-6. When the abrasive has a hardness less than 5.5, abrasives with small particle diameters will be produced due to the breakage and deformation of said abrasives which results in a very small change in glossiness and even the appearance of high glossiness, just like the polishing coarse grinding paste being sample #4; and an alumina abrasive with a Mohs' hardness of 6 or more has excellent polishing property when the particle size thereof is small, however, sand marks will be left when the particle size of the abrasive is 20-30 μm, just like the polishing coarse grinding paste being sample #5 described later.

The hardness in the invention is the Mohs' hardness measured according to the traditional methods such as the national correlative standards. The Mohs' hardness is a standard for indicating the hardness of minerals. By applying a scratching method, a scratching is produced by scratching the surface of a tested mineral using a pyramid-shaped diamond drill bit, and customarily, the Mohs' hardness is used in mineralogy and gemology. The hardness is classified into 10 grades using the measured depths of the scratchings: talc 1 (the smallest hardness), gypsum 2, calcite 3, fluorite 4, apatite 5, (feldspar; orthoclase; periclase) 6, quartz 7, topaz 8, corundum 9, diamond 10.

According to certain embodiments, the painted surface treating composition of the invention further comprises a rheological agent. Examples of the rheological agent include, but are not limited to, anionic hydrophobic-modified acrylic alkali-swelling thickening agents or the like.

According to certain embodiments, in the painted surface treating composition of the invention, said dispersed medium is an environmentally friendly water-oil dispersion emulsion. Wherein, the oil has a grinding aiding property, which can adjust the volatility so as to ensure that there is solvent in the process of the polishing process and the dry grinding of the abrasives will not occur; and simultaneous, can further ensure that the solvent can be removed easily after polishing In a preferable emulsion, the solvent content is low and therefore there is small harm to the environment.

According to certain embodiments, in the painted surface treating composition of the invention, said abrasive comprises 35-50% of the total weight of the system.

According to certain embodiments, in the painted surface treating composition of the invention, said abrasive is pyrolutite. Because pyrolutite has a particulate shape with obvious contour and stereo property, the grinding efficiency thereof is very high. The natural pyrolutite is a porous glassy acidic rock formed by the cooling of magma after volcano breaking forth, which has relatively many air pores, a very small relative density comparing with water such that it is capable of being floated on water, and is often appeared in nature in a manner of white or gray. Pyrolutite is a pure natural grinding material, which is nonflammable, corrosiveless, water absorbable and gas passable, and has a light weight. During the machining process of pyrolutite, it demands purely physical processing without any chemical treatment, and therefore, there is no pollution problem for the environment and there isn't any damage to human.

According to certain embodiments, in the painted surface treating composition of the invention, the particle diameter distribution D₉₀ of said abrasive is between 30-110 μm. This particle diameter distribution is a highly concentrated particle size distribution. Because the particle size distribution thereof is relatively narrow and concentrated, it favors the uniformity of the surface of the work piece after actual grinding. Thereby, it will neither leave sand marks of large particles nor produce high light effect of the micro-powder particles.

The invention further provides a painted surface treating method to including applying the painted surface treating composition of the invention on a substrate.

Still another aspect of the invention provides a painted surface defect patching method including applying the painted surface treating composition of the invention on a painted surface to be patched.

In the invention, unless specifically indicated, all of the percentages and parts are in terms of weight.

### EXAMPLES

### Testing Method

The glossiness was tested utilizing ASTM D523.

The Particle diameter and particle diameter distribution were tested by a JIS R6012 Coulter particle diameter counter.

Raw Materials:

Rheological agent: an anionic hydrophobic-modified acrylic alkali-swelling thickening agent.

Pyrolutite: HESS pyrolutite HP4 O/N KC-009 (with an average particle size of 54 μm), HESS pyrolutite Dymco325 KC-006 (with an average particle size of 38 μm), and HESS pyrolutite LHM-325 KC-003 (with an average particle size of 15 μm), all provided by Dymco Co. Ltd., Shanghai.

Physical Characteristics of the Pyrolutites:

Mohs' hardness: 5.5-6.0; acid-base property: 7.2; radiating energy: 0; combustion loss: 5%; Fe iron: without blue color; aqueous substance: 0.15%; acidic substance: 2.9%; softening temperature: 900 degree.

The Chemical Components of the Pyrolutites:

SiO₂: 70.5%; Al₂O₃: 13.5%; Fe: 0.1%; Fe₂O₃: 1.1%; H₂O: 3.4%; Na: 1.6%; K: 1.8%; Ca: 0.8%; TiO₂: 0.2%; SO₃: 0.1%; MgO: 5%.

The Formulation of a Grinding Dispersion Emulsion

A grinding dispersion emulsion was formulated according to the formula shown in Table 1. Under a condition of moderate speed (400-800 rounds/minute) stirring with a stirrer, the raw materials were added into a container successively according to the order and proportion shown in Table 1. After all of the raw materials had been added, the mixture was stirred for 15-20 min under a high rotating speed (1200-1600 rpm). Therefore, a stable grinding dispersion emulsion with an acid-base degree between 8.6 and 9.0 was obtained.

TABLE 1
The composition of a grinding dispersion emulsion

| | Types | Specific components | percentages | Suppliers |
|---|---|---|---|---|
| grinding | Deionized water | Deionized water | 25.66 | |
| dispersion | Acid-base | Triethanolamine | 0.2 | Shanghai Saifu |
| emulsion | adjusting agent | | | Chemical |
| | | | | Development Co., |
| | | | | Ltd. |
| | Dispersant | DisperBYK | 0.5 | BYK-Chemie |
| | | | | USA |
| | Emulsifying agent | Tween 80 | 1 | Shanghai Saifu |
| | | | | Chemical |
| | | | | Development Co., |
| | | | | Ltd. |
| | antimicrobial | Nuosept 95 | 0.19 | International |
| | | | | Specialty Products |
| | | | | Inc. |
| | Grinding aiding | Kerosene | 14 | Univar Chemical |
| | solvent oil | Turpentine 302 | 1.6 | Trade Co., Ltd. |
| | | White oil 110 | 4 | |
| | | Isopar M | 2 | Shanghai Best |
| | | | | Coating Chemical |
| | | | | Technology Co., |
| | | | | Ltd. |
| | | Red oil | 1.5 | Unichema |
| | | | | Chemicals Inc. |

### Examples 1-3

According to the formulas in Table 2-1 (example 1), 2-2 (example 2) and 2-3 (example 3) respectively, the respective components in these tables were formulated to obtain three kinds of painted surface treating compositions of the invention. The specific formulating method was as follows: under a condition of low speed (400-800 rpm) stirring with a stirrer, the raw materials were added into a container successively according to the order and proportion of the formulas for respective samples shown in Table 2. Firstly, half of the rheological agent was added and dispersed by high speed (3,000-5,000 rpm) stirring for 10-15 min. Then, under a condition of moderate speed (1,200-1,400 rpm) stirring, the rheological agent was added to adjust a viscosity of 12,000-20,000 centipoises. A stable grinding paste system with an acid-base degree between 8.2 and 8.4 was obtained.

TABLE 2-1
The component formula of sample 1

| Formula | Percentages | Suppliers |
|---|---|---|
| grinding dispersion emulsion | 50.65 | As shown in Table 1 |
| HESS pyrolutite HP4 O/N | 49 | Dymco Co. Ltd., Shanghai. |
| Rheological agent TT-615 | 0.35 | Rohm & Haas Company |

TABLE 2-2
The component formula of sample 2

| Formula | Percentages | Suppliers |
|---|---|---|
| grinding dispersion emulsion | 50.65 | As shown in Table 1 |
| HESS pyrolutite LHM-325 | 49 | Dymco Co. Ltd., Shanghai. |
| Rheological agent TT-615 | 0.35 | Rohm & Haas Company |

TABLE 2-3
The component formula of sample 3

| Formula | Percentages | Suppliers |
|---|---|---|
| grinding dispersion emulsion | 50.65 | As shown in Table 1 |
| HESS pyrolutite Dymco325 | 49 | Dymco Co. Ltd., Shanghai. |
| Rheological agent TT-615 | 0.35 | Rohm & Haas Company |

The painted surface treating compositions obtained in examples 1-3 were coated respectively on automobile painted surfaces and the glossiness change on the automobile painted surfaces was measured. The grinding paste was coated uniformly on a 3M 85078 white wool ball (2 grams), and a metal plate sprayed with an automobile painted surface was burnished for 15 sec using a 7403 burnisher under a pressure of 3 pounds, and then the surface of the painted surface was cleaned with a soft cloth. Then, a measurement was performed using a vancometer.

TABLE 3
Comparison of the glossiness on the automobile painted surfaces

| | Automobile painted plates | | | | | |
|---|---|---|---|---|---|---|
| | Glossiness | Example 1 | Glossiness | Example 2 | Glossiness | Example 3 |
| | of the | Sample #1, | of the | Sample #2, | of the | Sample #3, |
| Testing at | painted | after | painted | after | painted | after |
| 60° | plate itself | polishing | plate itself | polishing | plate itself | polishing |
| Glossiness 1 | 89.2 | 52.7 | 87.7 | 51.1 | 92.8 | 50.9 |
| Glossiness 2 | 86.5 | 58.1 | 85.9 | 48.6 | 92.8 | 51.2 |
| Glossiness 3 | 83.3 | 61.8 | 86.4 | 50.9 | 92.9 | 52 |
| Average | 86.3 | 57.5 | 86.7 | 50.2 | 92.8 | 51.4 |
| glossiness | | | | | | |

Wood painted surfaces were treated with the painted surface treating compositions obtained in examples 1-3 respectively and the glossiness change on the wood painted surfaces was measured. An ultrafine wire wool (3M Ultra Fine) was fit on a 30 pound vibrating burnisher. After being sprayed with clean water, the painted surface was burnished 3 times to obtain a uniform surface. Then, the grinding paste was coated uniformly on a 3M white wire wool (Type T) and the painted surface was burnished for 3-4 times using a 30 pound vibrating burnisher. The surface of the painted surface was cleaned with a soft cloth. Then, a measurement was performed using a vancometer.

TABLE 4
Comparison of the glossiness on the wood painted surfaces

| | Wood painted plates | | | | | |
|---|---|---|---|---|---|---|
| | Glossiness | | Glossiness | | Glossiness | |
| | of the painted | Sample #1, | of the painted | Sample #2, | of the painted | Sample #3, |
| Testing at | plate after | after | plate after | after | plate after | after |
| 60° | sand polishing | polishing | sand polishing | polishing | sand polishing | polishing |
| Glossiness 1 | 57.9 | 28.9 | 48.4 | 31.8 | 44.5 | 40.9 |
| Glossiness 2 | 50.9 | 23.4 | 53.1 | 34.8 | 43 | 31.6 |
| Glossiness 3 | 48.2 | 29.6 | 47.9 | 31 | 49 | 48.2 |
| Glossiness 4 | 36 | 22.6 | 49.7 | 32.6 | 49.6 | 27.7 |
| Glossiness 5 | 46 | 28.2 | 51.8 | 31.2 | 47.6 | 45 |
| Glossiness 6 | 44.4 | 23.4 | 47.3 | 36.9 | 44.4 | 41 |
| Average | 47.2 | 26 | 49.7 | 33.1 | 46.4 | 39.1 |
| glossiness | | | | | | |

Sample #1 had very minute scratchings after polishing Scratching could not be observed in sample #2 after polishing. Scratching could not be observed in sample #3 after polishing. Generally speaking, it could be proved after testing that the samples #1, #2 and #3 could make glossiness decrease about 30°. Simultaneously, this system was stable under a condition of room temperature and sealing. The utilizing process thereof was the same as that of the generally used painted surface patching system at present and could be used on the wood furniture painted surfaces and automobile painted surfaces conveniently.

### Examples 4-6

According to a method which was the same as that in example 3, painted surface treating compositions of the invention were formulated according to the formulas in the following Table 5-1 (example 4), Table 5-2(example 5) and Table 5-3 (example 6).

TABLE 5-1
The component formula of sample 3

| Formula | Percentages | Suppliers |
|---|---|---|
| grinding dispersion emulsion | 50.65 | As shown in Table 1 |
| HESS pyrolutite Dymoc-325 | 49 | Dymco Co. Ltd., Shanghai. |
| Rheological agent TT-615 | 0.35 | Rohm & Haas Company |

TABLE 5-2
The component formula of sample 3-2

| Formula | Percentages | Suppliers |
|---|---|---|
| grinding dispersion emulsion | 64.60 | As shown in Table 1 |
| HESS pyrolutite Dymoc-325 | 35 | Dymco Co. Ltd., Shanghai. |
| Rheological agent TT-615 | 0.40 | Rohm & Haas Company |

TABLE 5-3
The component formula of sample 3-3

| Formula | Percentages | Suppliers |
|---|---|---|
| grinding dispersion emulsion | 57.62 | As shown in Table 1 |
| HESS pyrolutite Dymoc-325 | 42 | Dymco Co. Ltd., Shanghai. |
| Rheological agent TT-615 | 0.38 | Rohm & Haas Company |

The painted surface treating compositions obtained in examples 4-6 were coated respectively on automobile painted surfaces and the glossiness change on the automobile painted surfaces was measured. The grinding paste was coated uniformly on a 3M 85078 white wool ball (2 grams), and a metal plate sprayed with an automobile painted surface was burnished for 15 sec using a 7403 burnisher under a pressure of 3 pounds, and then the surface of the painted surface was cleaned with a soft cloth. Then, a measurement was performed using a vancometer.

TABLE 6
Comparison of the glossiness on the wood painted surfaces

| | Wood painted plates | | | | | |
|---|---|---|---|---|---|---|
| | Glossiness | Example 4 | Glossiness | Example 5 | Glossiness | Example 6 |
| | of the painted | Sample #3 | of the painted | Sample #3-2 | of the painted | Sample #3-3 |
| Testing at | plate after | (49%), after | plate after | (35%), after | plate after | (42%), after |
| 60° | sand polishing | polishing | sand polishing | polishing | sand polishing | polishing |
| Glossiness 1 | 44.5 | 40.9 | 62.9 | 44.1 | 41.2 | 40.9 |
| Glossiness 2 | 43 | 31.6 | 55.7 | 38.1 | 43.6 | 42 |
| Glossiness 3 | 49 | 48.2 | 58.1 | 34.6 | 47.3 | 39.6 |
| Glossiness 4 | 49.6 | 27.7 | 56.4 | 39.3 | 48.8 | 43.1 |
| Glossiness 5 | 47.6 | 45 | 57.7 | 42.9 | 42 | 38.7 |
| Glossiness 6 | 44.4 | 41 | 48.5 | 38.7 | 43.6 | 38.4 |
| Average | 46.4 | 39.1 | 56.6 | 39.6 | 44.4 | 40.5 |
| glossiness | | | | | | |

For the abrasive of sample #3 (with an average particle diameter of about 38 μm), when the content thereof was between 35% and 50%, the glossiness of the paint on the carpentry surface could be about 40.

### Comparative Example 1

A painted surface treating composition of comparative example 1 was formulated according to the formula shown in Table 7-1. In the formula, the correlative physical properties of Double Cream Tripoli diatomite were as follows: Mohs' hardness: <5.5; acid-base property: 6.2-7.0; melting temperature 1707° C.; average particle diameter: 24 μm (all of them were supplied by the supplier). The testing results of glossiness thereof were listed in Table 8 and Table 9.

### Comparative Example 2

A painted surface treating composition of comparative example 2 was formulated according to the formula shown in Table 7-2. In the formula, the alumina was supplied by Quanzhou Huaming Trading Co., Ltd., and had a Mohs' hardness of 7.5-8.0 and an average particle diameter of 20-30 μm (both were supplied by Quanzhou Huaming Trading Co., Ltd.). The testing results of glossiness thereof were listed in Table 8 and Table 9.

TABLE 7-1
The component formula of a polishing coarse grinding
paste being sample #4

| Formula | Percentages | Suppliers |
|---|---|---|
| grinding dispersion emulsion | 50.65 | As shown in Table 1 |
| Double Cream Tripoli diatomite | 49 | American Tripoli Inc. |
| Rheological agent TT-615 | 0.35 | Rohm & Haas Company |

TABLE 7-2
The component formula of a polishing coarse grinding
paste being sample #5

| Formula | Percentages | Suppliers |
|---|---|---|
| grinding dispersion emulsion | 50.65 | As shown in Table 1 |
| Alumina micro-powder | 49 | Martin Alumina, Germany |
| abrasive | | |
| Rheological agent TT-615 | 0.35 | Rohm & Haas Company |

TABLE 8
Comparison of the glossiness on the automobile painted
surfaces

| | Automobile painted plates | | | |
|---|---|---|---|---|
| | | | | Comparative |
| | Glossiness | Comparative | Glossiness | example 2, |
| | of the | example 1, #4 | of the | #5 polishing |
| Testing at | painted | polishing coarse | painted | coarse |
| 60° | plate itself | grinding paste | plate itself | grinding paste |
| Glossiness 1 | 91.8 | 87.8 | 90.7 | 73.7 |
| Glossiness 2 | 92.2 | 87.1 | 90.2 | 71.7 |
| Glossiness 3 | 92.3 | 86.7 | 90 | 68.9 |
| Average | 92.1 | 87.2 | 90.3 | 71.4 |
| glossiness | | | | |

TABLE 9
Comparison of the glossiness on the carpentry painted
surfaces

| | Glossiness | Comparative |
|---|---|---|
| | of the | example 1, |
| | painted plate | sample #4, |
| Testing at | after sand | after |
| 60° | polishing | polishing |
| Glossiness 1 | 34.7 | 67.1 |
| Glossiness 2 | 35.2 | 65.1 |
| Glossiness 3 | 34.9 | 66.7 |
| Glossiness 4 | 36.8 | 63.4 |
| Glossiness 5 | 38.5 | 66.7 |
| Glossiness 6 | 44.4 | 71.3 |
| Average | 37.4 | 66.7 |
| glossiness | | |

It could be seen from Table 8 that sample #4 and sample #5 both would change the surface glossiness of the metal paint. However, some scrapes would appear in sample #5. The data of sample #4 were shown in Table 9 to which indicated that sample #4 could make the glossiness of the painted surface reach about 60-70 and had a certain effect for increasing the glossiness.

1. A painted surface treating composition, comprising a dispersion medium and an abrasive dispersing in the dispersion medium, said abrasive has an average particle diameter of 12-55 μm and a Mohs' hardness of 5.5-6.

2. The painted surface treating composition according to claim 1, further comprising a rheological agent.

3. The painted surface treating composition according to claim 1, wherein the rheological agent is an anionic hydrophobic modified acrylic base swelling thickening agent.

4. The painted surface treating composition according to claim 1, wherein the dispersion medium is a water oil dispersion emulsion.

5. The painted surface treating composition according to claim 1, wherein the amount of abrasive is 35-50% of the total weight of the composition.

6. The painted surface treating composition according to claim 1, wherein the abrasive is pyrolutite.

7. The painted surface treating composition according to claim 1, wherein a particle diameter distribution D₉₀ of the abrasive is between 30-110 μm.

8. A painted surface treating method, comprising a step of applying the painted surface treating composition according to claim 1 on a substrate.

9. A painted, surface defect patching method, comprising a step of applying the painted surface treating composition according to claim 1 on a painted surface to be patched.
